(19) United States
(12) Patent Application Publication
(10) Pub. No.: US 2013/0324204 A1
(43) Pub. Date: Dec. 5, 2013

(54) METHODS AND APPARATUS FOR GAMES THAT PERMIT REWAGERING

(71) Applicants: Roger M. Snow, Las Vegas, NV (US); Jennifer K. Farrar, Las Vegas, NV (US)

(72) Inventors: Roger M. Snow, Las Vegas, NV (US); Jennifer K. Farrar, Las Vegas, NV (US)

(21) Appl. No.: 13/483,983

(22) Filed: May 30, 2012

(51) Int. Cl. A63F 1/00; A63F 13/00; A63F 9/24

(52) U.S. Cl. 463/12; 273/292; 463/26; 463/13

(57) ABSTRACT

Methods of administering wagering games comprise accepting a first wager to participate in a first wagering game according to a first set of game rules. A second wager to participate in a second, different wagering game according to a second, different set of game rules is accepted. The second wager is resolved according to the second set of game rules. An instruction is accepted from each player who won the second wager to award at least a portion of winnings from the second wager directly to the player or to add at least a portion of winnings from the second wager to the first wager. The first wager is resolved according to the first set of game rules. Games of the present invention may be implemented as live card games, EGM games, multi-player EGM games, on-line games, scratch ticket games and live card games with electronic betting interfaces.

### FIELD

The disclosure relates generally to methods of administering wagering games for casinos and other gaming establishments, and related systems and apparatuses. More specifically, disclosed embodiments relate to methods of and systems and apparatuses for, administering wagering games including at least one side wager, at least winnings from which may be added to another wager in the same round of play.

### BACKGROUND

Blackjack is a popular wagering game played in casinos and other gaming establishments. Some alterations to traditional blackjack have been proposed, including side bets made while playing blackjack. For example, the ROYAL MATCH 21® game is a side bet on blackjack focusing on the first two cards a player is dealt. To begin each round, players make the standard blackjack wager and the ROYAL MATCH 21® side wager. Players are dealt their first two cards and, if the cards are the same suit or a king and queen in suit—they win. If both the player and the dealer receive a king and queen in suit, an optional CROWN TREASURE™ bonus payout is awarded. The bonus payouts apply to the player's first two cards only. As another example, the BET THE SET 21® game also focuses on a player's first two cards dealt. To begin each round, players make their standard blackjack wagers and the BET THE SET 21® side wager. Once each player has received his first two cards, the dealer settles all side wagers. If a player has any pair, they win according to a posted pay table. As yet another example, KING′S BOUNTY™ blackjack is a blackjack side bet that pays when a player's first two cards has a numerical point total 20. All face cards have a point value of 10. To play, players make a standard blackjack wager and the side bet. The dealer deals blackjack according to house procedures. Players win the side bet if the point value of the first two player cards adds up to 20. The top award occurs when a player has two kings of spades and the dealer has blackjack. This top award may only be achieved when the game is dealt from a multiple deck shoe.

### BRIEF SUMMARY

In some embodiments, methods of administering wagering games comprise accepting a first wager to participate in a first wagering game according to a first set of game rules. A second wager to participate in a second, different wagering game according to a second, different set of game rules is also accepted. Cards are dealt to each player and to a dealer. The second wager is resolved according to the second set of game rules. When a payout is awarded to the player on the second wager, an instruction is accepted from each player to award at least a portion of winnings from the second wager directly to the player or to add at least a portion of winnings from the second wager to the first wager. All or a portion of the second wager may also be added to the first wager. The first wager is resolved according to the first set of game rules. In some embodiments, the first wager is mandatory and the second wager is optional. In other embodiments, both the first and second wagers are mandatory.

In one embodiment, methods of administering wagering games comprise the dealer accepting a second wager to participate in a variant of a two-card poker game, and the dealer accepting a first wager to participate in a game of blackjack. The second wager is optional in this example of the invention. Two cards are dealt to each player and to a dealer. The second wager, if played, is resolved according to whether the two cards of each player constitute a two-card poker hand of a predetermined rank or higher. An instruction is accepted from each player in whose favor the second wager is resolved to award at least a portion of winnings from the second wager directly to the player or to add at least a portion of winnings from the second wager to the first wager. All or a portion of the second wager amount may also be added to the first wager in some examples of the invention. The second wager is resolved according to blackjack rules.

In another embodiment, the first set of game rules comprises a three-card poker hand against a dealer hand, using a known three-card poker ranking system. Players view the cards, and either make a play wager equal to the first wager, or in other embodiments, the player may check. The second set of game rules is a three-card poker game against a pay table of predetermined winning outcomes and predetermined payout odds. The second wager in one embodiment is mandatory, but can also be optional.

In yet another embodiment, the first set of game rules comprises a modified form of baccarat, in which the dealer and each player receives three cards each, and the hands are scored according to baccarat rules. Each card is assigned a point value, and the point values are combined, modulo 10. The hand closest to 9 wins. Ties are resolved in favor of the house. The rules deviate from conventional baccarat in two important ways. Each player receives a separate hand of cards, and each hand has three cards. The second set of game rules comprises the player making a best three-card poker hand, and playing against a pay table of a plurality of predetermined winning payouts and payout odds. In this embodiment, there may be a third game segment in which the player makes a third wager before receiving cards, and plays a three-card poker game against a dealer hand, the second set of rules comprising known three-card poker rankings. The rules may require the player to make a play wager or fold before the dealer reveals the dealer cards in the first game. Alternatively, the player may be permitted to make a play wager or check. Checking allows the player to stay in the game without further betting. Amounts wagered and/or payouts in the first and second segments may be combined with the third wager, or the third wager may payout according to predetermined payout odds, such as 1:1 for example.

In one form of the invention, games may be played on a standard gaming table with a cloth surface. Cards may be randomized with an automatic card shuffler, and the same shuffler may be used to dispense packets of cards to the player and the dealer. Alternatively, cards may be shuffled and then transferred into a shoe for manual delivery by a dealer.

In some embodiments, gaming tables for administering wagering games comprise a playing surface including at least one player interface, at least one dealer interface, and at least one processor. The at least one processor is programmed to accept a first wager to participate in a first wagering game according to a first set of game rules and to accept a second wager to participate in a second, different wagering game according to a second, different set of game rules. The at least one processor is programmed to resolve the second wager according to the second set of game rules and to accept from each player in whose favor the second wager is resolved an instruction to award at least a portion of winnings from the second wager directly to the player. The processor may also receive an instruction to add at least a portion of winnings from the second wager to the first wager. The at least one processor is also programmed to resolve the first wager according to the first set of game rules.

Games of the present invention may be played on an electronic gaming machine (EGM), or on a multiple-player electronic game machine. In electronic forms of the game, a game display is provided to display game results. A processor is programmed to execute first and second sets of game rules. Player inputs are provided so that the processor can receive instructions to execute game play. When games of the present invention are executed on a multiple-player electronic game machine, all players in an embodiment simultaneously play the same game, to simulate live table game play. A common player display may be provided to display game pieces and game outcomes.

In yet other embodiments, systems for administering wagering games over computer networks comprise a game engine configured to be accessed by a client server over a network. The game engine is programmed to accept an instruction from a client server to place a first wager to participate in a first wagering game according to a first set of game rules and to accept an instruction from the client server to place a second wager to participate in a second, different wagering game according to a second, different set of game rules. The game engine is programmed to resolve the second wager according to the second set of game rules and to accept an instruction from each player for whom the second wager is resolved favorably an instruction to award at least a portion of winnings from the second wager directly to the player or to add at least a portion of winnings from the second wager to the first wager. The game engine is also programmed to resolve the first wager according to the first set of game rules.

### BRIEF DESCRIPTION OF THE DRAWINGS

While the specification concludes with claims particularly pointing out and distinctly claiming what are regarded as embodiments of the disclosure, various features and advantages of embodiments encompassed by the disclosure may be more readily ascertained from the following description when read in conjunction with the accompanying drawings, in which:

FIG. 1 is a flow diagram of a method of administering a wagering game;

FIG. 2 is a diagram of a live gaming table implementation of a first example of a wagering game;

FIG. 3 is an expanded view of a player area of a first example of the invention;

FIG. 4 is a diagram of a live gaming table implementation of a second example of a wagering game;

FIG. 5 is an expanded view of a player area of a second example of the invention;

FIG. 6 is an expanded view of a player area of a third example of the invention;

FIG. 7 is an example of an individual electronic gaming device configured for implementation of embodiments of wagering games;

FIG. 8 is an example of a suitable table with electronic player interfaces configured for implementation of embodiments of wagering games;

FIG. 9 is an example of a suitable multiple player electronic gaming machine configured for implementation of embodiments of wagering games having a virtual dealer;

FIG. 10 is a schematic block diagram of a gaming system 400 for implementing waging games according to an embodiment;

FIG. 11 is a high-level block diagram of a computer 500 for acting as a gaming system 400 according to one embodiment; and

FIG. 12 is a schematic of a scratch card implementation of a wagering game.

### DETAILED DESCRIPTION

The illustrations presented herein are not meant to be actual views of any particular act in a method of administering a wagering game, apparatus for use in administering a wagering game, or component thereof, but are merely idealized representations employed to describe illustrative embodiments. Thus, the drawings are not necessarily to scale. Additionally, elements common between figures may retain the same or similar numerical designation.

The terms “gaming,” “gambling,” or the like, refer to activities, games, sessions, rounds, hands, rolls, operations, and other events related to wagering games. Examples of wagering games include: live casino games, such as live card games, dice games, wheel games; electronic gaming machine games; multi-player electronic gaming machine games; games played on tables that are equipped with electronics to electronically measure or accept wagers, and/or electronically accept cards; and on-line games and other games of chance for which wagers may be placed by a player and payouts awarded. In addition, the word “wager,” “bet,” “bid” or the like, refer to any type of wagers, bets or gaming ventures that are placed on random events, whether of monetary or non-monetary value. Wagers may represent monetary amounts or non-monetary amounts. For example, players may wager, win and lose amounts of value or non-monetary points. Chips, credits, and other items of value, or points of non-monetary value may be issued, purchased, earned, or otherwise dispensed prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that are “play for pay” as well as “play for fun,” as will be described in more detail below.

Disclosed embodiments relate generally to methods of administering wagering games including at least one first bet, and a second bet. According to the invention, at least a portion of the winnings from the second bet may be added to the first bet and put at risk in the same round of play. The second bet may be optional or mandatory in different embodiments.

Various platforms are contemplated that are suitable for implementation of embodiments of wagering games according to the present disclosure. For example, wagering games may be implemented on a live gaming table, which may include physical game elements such as physical cards, physical chips, an automatic card handling device, a card dispensing shoe, a no-peek device, or a dealer instruction display, and may include a live dealer. More specifically, a live dealer may deal physical cards, accept wagers, issue payouts, accept elections, combine wagers, take wagers and perform other administrative functions of game play.

Some embodiments may be implemented on electronic devices enabling electronic gaming features, such as providing electronic displays for display of virtual cards, virtual chips, game instructions, pay tables, game outcomes, credit balances, play options, etc. Exemplary electronic devices are adapted for single players or for multiple players to engage in the same game. Other embodiments may include features that are a combination of physical and electronic features. Yet other embodiments are implemented for on-line, web-based play.

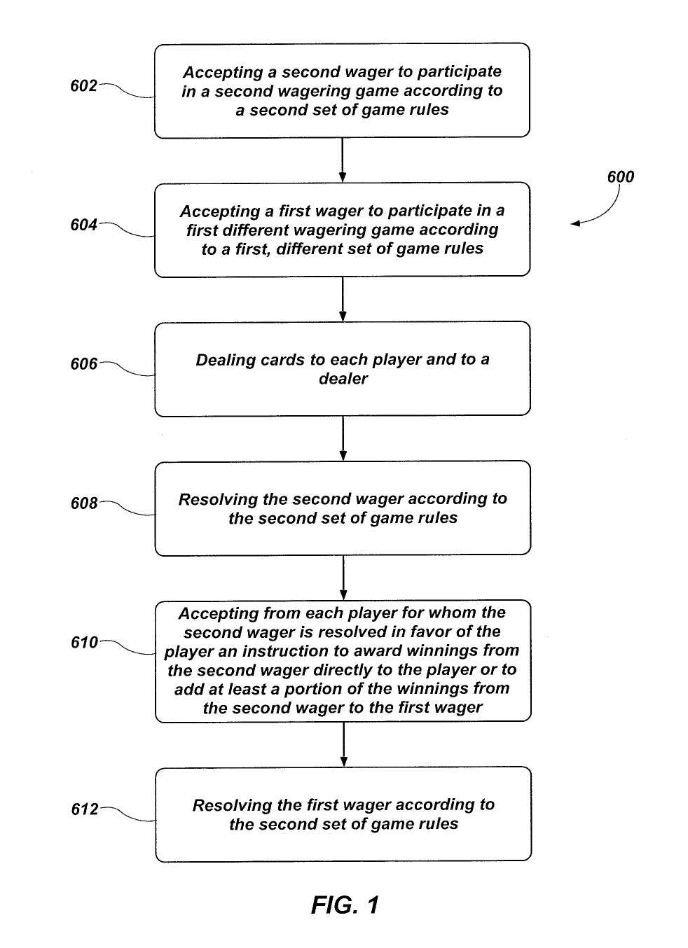

A flow diagram illustrating methods of the present invention is illustrated in FIG. 1. To begin play, a second wager is accepted 602 by the dealer from each player to qualify the player to participate in a second wagering game according to a second set of game rules. In some embodiments, the second wager is mandatory. In other embodiments, the second wager is optional. In forms of the invention, the second set of game rules includes consideration of a player hand only and not consideration of a dealer hand. It is therefore desirable to keep all dealer cards face down until the second wager is resolved. For example, the second set of rules may comprise comparing a player's two-card poker hand against a pay table of predetermined winning hand combinations and corresponding payout odds.

According to examples of the invention, a first wager is accepted 604 by the dealer from each participating player to participate in a first, different wagering game according to a first, different set of game rules. In some embodiments, the different set of game rules considers player cards as well as dealer cards in determining game outcome. In embodiments that require the dealer to accept a second wager from the player to qualify the player to participate in the game, the second wager is played first, and then the first wager is played, in order to prevent the player from viewing the dealer cards before play of the first wager. In embodiments where the second wager is optional, when the dealer receives an election from the player not to make the second wager, the first wager is played first. The second set of game rules may include blackjack rules, and may allow the players and dealer to initially receive two cards. Players and the dealers to accept additional hit cards, accept insurance wagers, accept elections to split pairs, etc. as with standard blackjack rules. In some forms of the game, the second game is played first, and the first game requires consideration of more cards than the second game, allowing for suspense to build as the game proceeds.

In examples of the invention, the method includes dealing cards to each player and to a dealer 606. The second wager is resolved according to the second set of game rules 608. The dealer cards may be dealt face down, and the second wager resolved first according to the second set of game rules, and without considering the dealer cards, in order to keep the player engaged and build excitement for the resolution of the first wager. In other embodiments, dealer cards may be used to resolve the second wager.

An exemplary method includes the step of accepting from each player for whom the second wager is resolved in favor of that player an instruction 610 to award at least a portion of winnings from the second wager directly to the player or to add at least a portion of winnings from the second wager to the first wager. The player has the choice of receiving the wager and payout on the second wager, or applying all or part of the wager and payout to the first wager. In some embodiments, only all or part of the payout amount can be combined with the first wager. Regardless of the amount of the second wager payout that is applied to the first wager, allowing the player to put payouts from a game at risk in the same game creates the impression that the player is being permitted to play with the casino's money. However, the player has already won these amounts and is free to take these payouts rather than bet them. For those players who like to win larger payouts, these amounts can be re-played in the same round, giving the player the potential of increasing payouts.

According to the invention, the first wager is resolved 612 according to the first set of game rules. In some examples of the invention, the first set of rules comprises blackjack rules. In other examples of the invention, a baccarat hand scoring system is applied to compare the total point value of the player and dealer hands, modulo 10. In yet other examples of the invention, the first set of rules comprises the players playing a three-card poker hand against a three-card dealer's poker hand.

Some embodiments of the method of the present invention includes dealing the players a two-card hand, and resolving the second wager by determining if the player holds a two-card poker hand of a predetermined rank or higher. This step may be performed before the first wager is resolved. The second set of game rules can include comparing a player hand with a set of predetermined winning poker hands. The poker hand ranking systems are well-known and depend upon the number of cards the player may use to make a poker hand. For example, the hierarchy of two-card poker hands is different from three-card, and five-card poker rankings.

Players may receive cards to make a best two-, three-, four-, five-, six- or seven-card poker hand, for example. The different set of game rules may be selected from the group consisting of two-card poker rankings, three-card poker rankings, four-card poker rankings, five-card poker rankings, six-card poker rankings and seven-card poker rankings. Other alternative embodiments include allowing players to discard and receive one or more cards to better their hand, include one or more extra wild cards or designate one or more cards in the set as wild.

In the examples described below, players receive the exact number of cards used to make a hand. In other embodiments, players are dealt one or more extra cards and then can make a best hand from the available cards. For example, in embodiments that require the dealer to dispense an extra card to each player for a two-, three-, four-, five-, six- or seven-card poker game, the dealer would deal to each player 3, 4, 5, 6, 7, or 8 cards, respectively. In some forms of the game, all of the player cards are dealt to a player position and are used exclusively by the player who made the wager or wagers. In other embodiments, one or more of the player cards are dealt to a common card position. Cards dealt to the common card position may be used by all players, the dealer or just some of the players, depending upon the game rules.

Blackjack/Two-Card Poker Against a Pay Table

In one example of the invention, the dealer administers a first wagering game of blackjack and a second wagering game of two-card poker. According to the second set of rules, the two-card poker game is played against a pay table and is played first, before the dealer hand is revealed to the player. The method includes the steps of accepting a first wager to participate in a game of blackjack. The method also includes accepting a second wager to participate in a variant of a two-card poker game. Two cards are dealt to each player and to a dealer. The second wager is resolved according to whether the two cards of each player constitute a two-card poker hand of a predetermined rank or higher. The method includes accepting from each player in whose favor the second wager is resolved an instruction to award at least a portion of winnings from the first wager directly to the player or to add at least a portion of winnings from the second wager to the first wager or to receive a payout. The first wager is then resolved according to blackjack rules.

The two-card poker game is resolved by the dealer examining the player cards to determine if the player holds a two-card straight, a pair, a straight flush, or an ace and a king of the same suit. Two examples of suitable pay tables are provided below. The first pay table may be used when multiple decks of cards are used in the play of the game. The second pay table may be used when a single deck of cards is used in the play of the game.

TABLE I

| Hand | Odds |
|---|---|
| Ace-king suited | 9 to 1 |
| Straight flush | 4 to 1 |
| Pair | 3 to 1 |
| Straight | 1 to 1 |

TABLE II

| Hand | Odds |
|---|---|
| Ace-king suited | 9 to 1 |
| Straight flush | 5 to 1 |
| Pair | 3 to 1 |
| Straight | 1 to 1 |

In some embodiments, the second wager is optional. If the dealer does not receive a player election to play the second wager, the player simply plays the first wager. In other embodiments, the second wager is mandatory. The second wager is resolved prior to resolving the first wager, otherwise the dealer cannot receive an election to move the wager to the first wager area before the first wager is resolved.

When the player wins the second wager, the dealer may receive a play election to move all of the amounts won on the second wager, plus the amount of the second wager to the first wager betting spot.

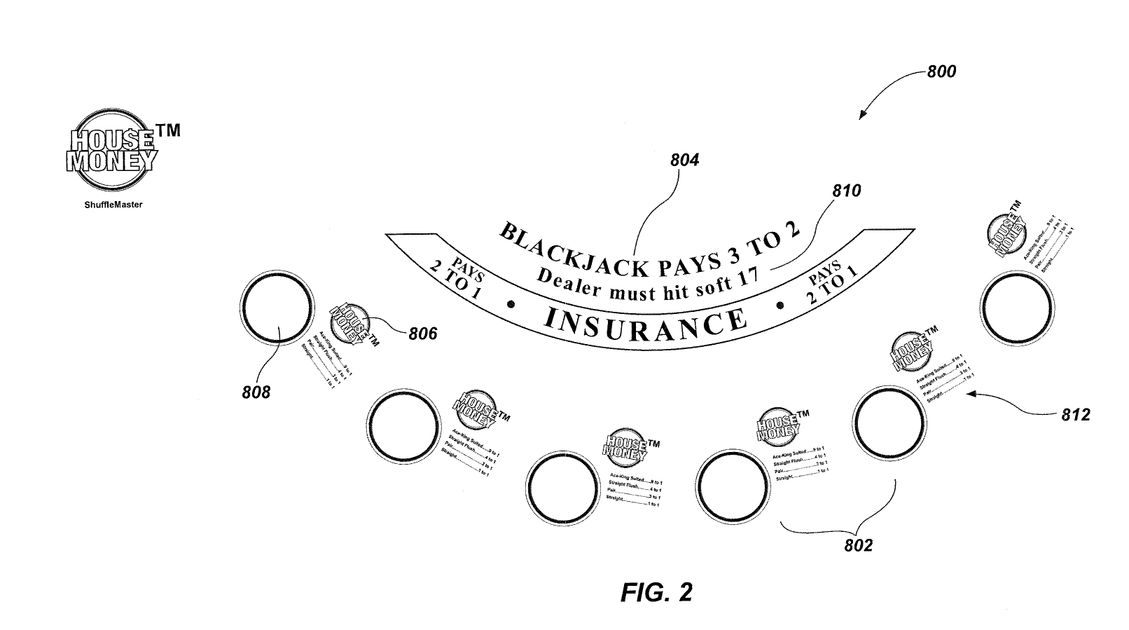

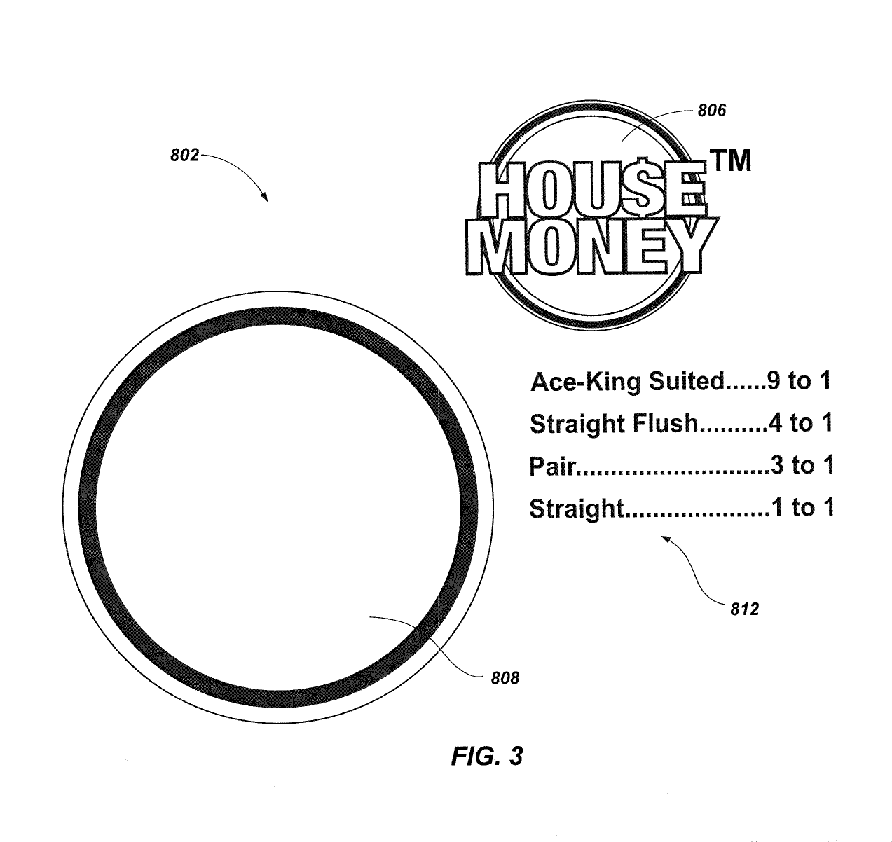

As illustrated in FIG. 2, this example of the game may be played on a cloth layout 800 with printed information and graphical designs. The layout 800 may include player areas 802, a dealer area 804, printed rules 810 for the first game, and printed rules 812 for the second game. The dealer may receive the first wager on betting spot 808, which designates participation in a blackjack game. Players may optionally make the second bet on betting spot 806. The second bet is a two-card poker bet against a pay table, in which the player hopes to receive a two-card hand of a straight, a pair, a straight flush, or a royal flush. The printed rules 812 preferably includes a pay table, which is shown in greater detail in FIG. 3. Each player area 802 includes a first wager area 808, a second wager area 806 and printed rules 812 comprising a pay table.

According to this embodiment, the dealer deals two cards to the dealer position 804 and two cards to each player position 802, face down. Dealer cards remain face down while the second game is being played. The two-card poker game is played first. The dealer examines the player hands and compares the hand ranking to the pay table 812 of winning hands and corresponding payout odds. If a predetermined winning hand is obtained, such as a straight flush, the dealer pays the player according to the odds posted in the pay table. In this example, the minimum ranking hand that is a winning hand is a straight or better. For a straight flush, the odds payout is 4:1. The amount wagered is multiplied by four to arrive at the payout amount. The amount wagered, the payout amount, part of the amount wagered, or part of the payout amount, or combinations thereof may be distributed to the player, or may be added to the first wager, at the option of the player. The dealer cards are not considered when resolving the second wager in this embodiment. If the player does not hold a predetermined winning two-card poker hand, the second wager is taken by the house, and play continues. In this embodiment, the first wager is mandatory.

If the player holds a winning hand, the dealer must receive an election from the player to move all or part of the second wager and the second payout to the first wager area, or pay the player a payout. After all or part of the second wager and payout is paid out or moved, play continues. It is to be understood that in some embodiments, the second wager is optional. In the event that a player elects not to make a second wager, the player will only play the first game, and the first game will be played first by that player. The dealer may receive second wagers from other players at the same table who may play the second game before the first game.

In this example of the game, the first wager 808 is made on a blackjack game. The players and dealer each receive a two-card hand. The player uses the same two cards used to resolved the second wager to resolve the first wager. After the second two-card poker game is played, blackjack play continues, except that when the dealer is dealt a two-card blackjack, play ends for the players, and the players cannot move all or part of the second wager or proceeds from the second wager to the first wager spot. The dealer deals players hit cards or receives elections to stand according to player requests, and the dealer takes hit cards and makes stand decisions according to house rules. For example, if the rules of the first game 810 include the requirement that the dealer hit on a soft 17, the dealer cannot deviate from this rule. The highest ranking hand that does not exceed a point count of 21 wins the round. If the player beats the dealer with less than a blackjack, the player is paid 1:1. If the player has a blackjack and beats the dealer hand, the player is paid 3:2. Other blackjack rules such as double downs, insurance bets and card splitting can be included as part of the rules of the first game. The first wager may be resolved using blackjack rules. In some embodiments of the present invention, the second wager is optional. In other embodiments such as with one of the examples below, the second wager is mandatory.

Some players prefer to go “all in” and put all available wagers at risk. In this instance, examples of the present method would allow the player to move all amounts wagered and all amounts paid on the second wager to the first wager position. Examples of the present invention may allow for more conservative betting, allowing the dealer to accept a wager that represents a portion of the second wager or the second payout amount and combine that wager with the first wager. In one embodiment, the dealer requires players that have won the second wager to put all of the second wager and second wager payout amounts on the first wager betting circle.

Three-Card Poker Against a Dealer Hand/Three-Card Poker Pay Table Game

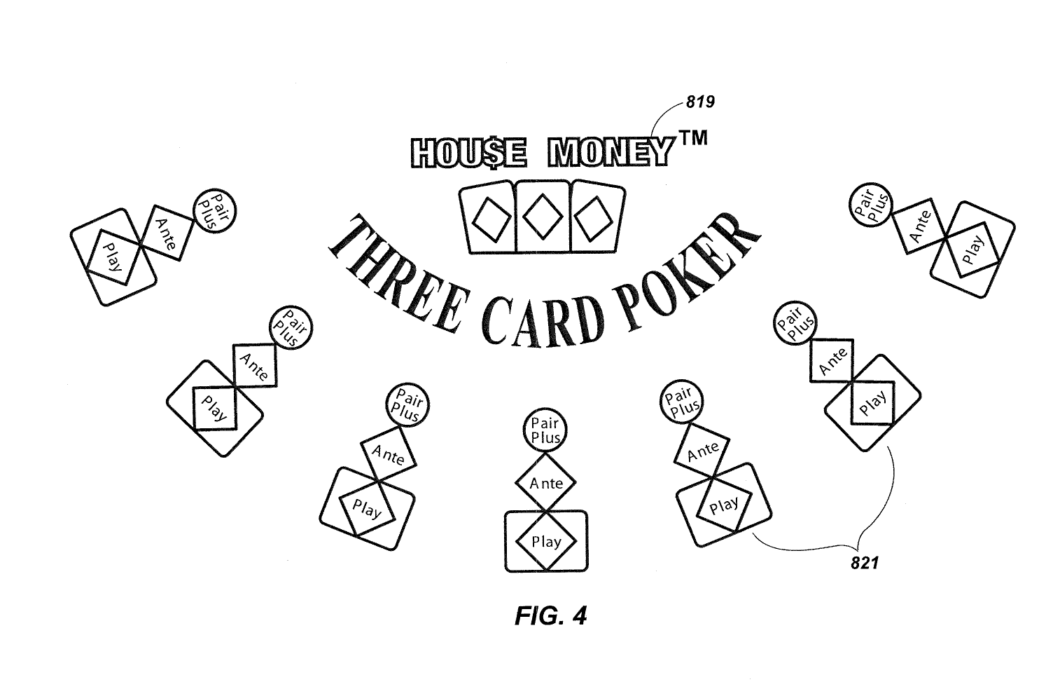

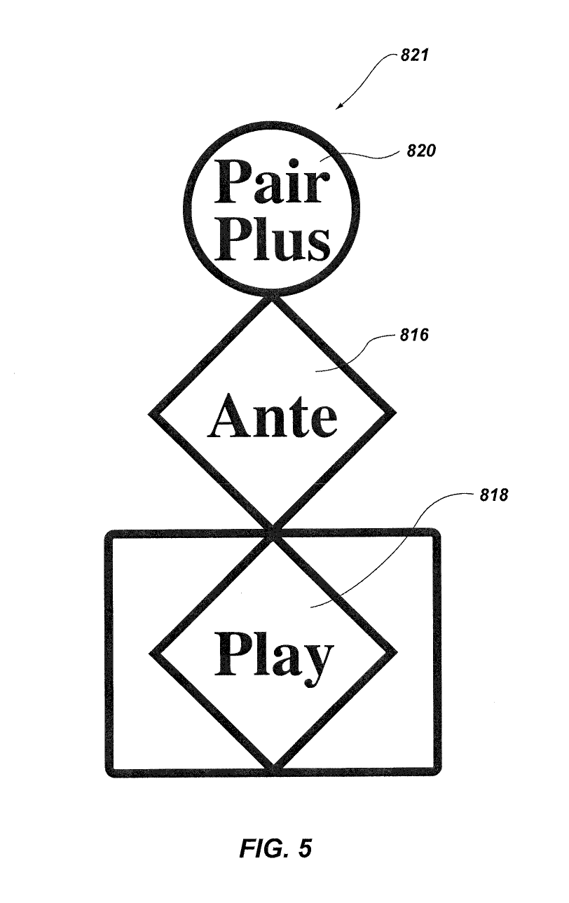

In another example of the invention, the first set of game rules comprises dealing three cards to each player and to the dealer, and comparing a point value of the player hands to the dealer hand, wherein three-card poker rankings are used to determine the winning hand. The game can be played on a suitable table surface, as shown in FIG. 4. A gaming table surface 819 is provided with multiple player areas 821. The first set of game rules is preferably played first, and comprises the player playing a three-card poker game against a pay table of predetermined winning hands and corresponding payout odds. The dealer's cards remain face down on the table while the second wager is being played. FIG. 5 is an expanded view of a player play area 821. According to this example, the first game is a three-card poker game against a dealer hand. The dealer may receive a first wager, also known as an ante wager from the player, the ante wager being the first wager, and placed in the ante betting circle 816. When the second game is a three-card poker game against a pay table, the player can make a second “pair plus” wager on betting circle 820. In this example of the game, both the ante and pair plus bets are mandatory, and the minimum winning hand on the pair plus wager is a pair or better. In other embodiments, other minimum hand rankings are the minimum winning ranking, such as a flush or better. In one embodiment, the player views his hand and the dealer receives an election to either fold or make a play wager in betting circle 818. In one embodiment, the play wager is equal to the ante. In other examples, the play wager is a multiple of the ante.

In other examples (not shown), the dealer receives an election to make a play wager or check, and the player may not elect to fold. No further betting is needed when the dealer receives a check election from the player. In yet another example, the dealer does not receive an election from the player to keep the ante wager in play, and no further wagering to keep the ante in play is allowed under the rules.

The second wager 820 is resolved first, before the dealer hand is revealed. If the player holds a predetermined winning hand, that wager is paid posted odds. The dealer then receives an election to either pay out all or portion of the pair plus wager 820 and corresponding payouts or combine the wager with the first ante wager 816. If the player holds less than the predetermined minimum winning hand, the house takes the bet on betting circle 820.

The dealer reveals the dealer hand. Player and dealer hands are compared and the dealer takes the ante (and play wager, if made) when the dealer hand outranks the player hand and pays the player a predetermined payout such as 1:1 or 2:1 on the ante (and play, when made) when made when the player hand outranks the dealer hand, using standard three-card poker hand rankings. In some forms of the invention, the dealer hand must qualify, such as with a queen-high or better, otherwise the ante, play or ante and play bets push. Alternatively, the ante or play can push and the other bet (the play or ante) can pay 1:1, depending on the desired house odds.

The second set of rules may comprises a three-card poker pay table such as Pay Table III below:

TABLE III

| Hand | Odds |
|---|---|
| Straight flush | 40 to 1 |
| 3 of a kind | 30 to 1 |
| Straight | 6 to 1 |
| Flush | 4 to 1 |
| Pair | 1 to 1 |

Automatic ante bonus odds payouts or fixed payout amounts for certain high-ranking hands, such as a straight or better may also be paid.

Three-Card Poker Pay Table/Three-Card Baccarat

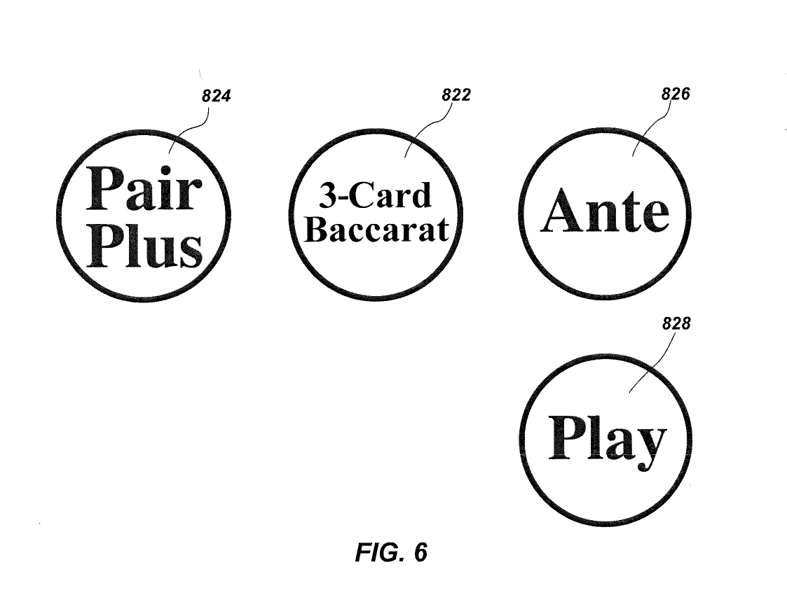

In another example of the invention, players and the dealer make a mandatory first three-card baccarat bet 822 as shown in FIG. 6, a mandatory “pair plus” second bet 824 and an optional ante bet 826. The ante bet 826 in another example of the invention is mandatory. In alternate finals of the invention, no ante bet is offered.

The second wager 824 is played first, in order to avoid exposing dealer cards to the player and in order to maintain suspense in the game. After the dealer receives a player election to make a play wager or fold, the former keeping the ante in play and the latter resulting in a loss of the ante, the dealer reviews the player's revealed hand. If the player holds a predetermined winning hand as shown in Pay Table III, above, the dealer may receive an election to pay the player a payout on the second wager, and return the second wager to the player, or put all or part of the funds eligible for return on the baccarat bet. If the player holds a lower ranking poker hand than the minimum winning poker hand, the dealer takes the wager on betting spot 824.

Prior to playing the second wager, or after the second wager is played but before the first wager is played, players who made the ante wager view the player cards and elect to make a play wager 828, or check. The dealer then receives the election, including the check or the play wager 828. The ante wager 826 stays in play. In other forms of the invention, the player must make a play wager 828 or fold. In some embodiments, the ante wager is not offered.

After the play or check election is received, the first wager is resolved. The dealer reveals the dealer cards, and at this point, all player and dealer cards are exposed. The first wager 822 is made on the occurrence of a player three-card hand having a higher ranking hand than a dealer three-card hand, using baccarat scoring, modulo 10 as the rules of the first game. Unlike standard baccarat, no hit cards can be taken

The player wins 1:1 on the baccarat bet if the player hand beats the dealer hand. Ties go to the house. The dealer takes all bets if the dealer hand outranks the player hand. Last, all ante and play wagers or just ante wagers are resolved by comparing the player hand rank to the dealer hand rank.

Other Game Formats

The present invention may also be characterized as a gaming table or a gaming system for administering a wagering game, comprising: a playing surface including at least one player interface; at least one dealer interface; and at least one processor programmed to: accept a first wager to participate in a first wagering game according to a first set of game rules; accept a second wager to participate in a second, different wagering game according to a second, different set of game rules; resolve the second wager according to the second set of game rules; accept from each player in whose favor the second wager is resolved an instruction to award at least a portion of winnings from the second wager directly to the player or to add at least a portion of winnings from the second wager to the first wager; and resolve the first wager according to the first set of game rules. The processor may be programmed to resolve the second wager according to whether the player hand is of a predetermined minimum winning poker rank or higher. Examples of winning poker hands include: a straight, a pair, a straight flush, or an ace and a king of the same suit. According to examples of the invention, processor may be programmed to resolve the first wager according to a first set of rules, such as blackjack, three-card poker, four-card poker, five-card poker, six-card poker, seven-card poker or baccarat rules.

When the second wager is resolved in favor of the player, the system may accept an instruction to add all or part of the winnings from the second wager to the first wager. In examples, an instruction to add all of the second wager winnings to the first wager may be accepted. The processor may be programmed to treat the second wager as optional.

The present invention may also be characterized as a system for administering a wagering game over a computer network, comprising: a game engine configured to be accessed by a client server over a network, the game engine being programmed to: accept an instruction from a client server to place a first wager to participate in a first wagering game according to a first set of game rules; accept an instruction from the client server to place a second wager to participate in a second, different wagering game according to a second, different set of game rules; resolve the second wager according to the second set of game rules; accept an instruction from each player for whom the first wager is resolved favorably an instruction to award at least a portion of at least one of the second wager and winnings from the second wager directly to the player or to add all or a portion of the amounts to the first wager; and resolve the first wager according to the first set of game rules.

The system may be programmed to treat the second wager as optional or mandatory. The second wager may be resolved according to whether the two cards of each player constitute a two-card poker hand of a predetermined rank or higher. The game engine may be programmed to resolve the second wager according to whether the two cards of each player constitute a two-card poker hand of a straight, a pair, a straight flush, or an ace and a king of the same suit. In some embodiments, the game engine is programmed to resolve the first wager according to blackjack rules. When the first game is blackjack, the game engine may be programmed to return the second wager and winnings on the second wager to the player when the dealer hand is a blackjack.

Embodiments of the present invention include electronic gaming machines that perform the steps of the methods described herein. For example, an electronic gaming machine may be provided for administering a wagering game, comprising: at least one player display and at least one player interface; wherein the player interface enables a player to input a wager instruction; at least one processor programmed to: accept a player first wager instruction to participate in a first wagering game according to a first set of game rules; accept a player second wager instruction to participate in a second, different wagering game according to a second, different set of game rules; display a game result; resolve the second wager according to the second set of game rules; accept from each player in whose favor the second wager is resolved an instruction to award at least a portion of winnings from the second wager directly to a player account or to add at least a portion of winnings from the second wager to the first wager; and resolve the first wager according to the first set of game rules based on at least the same displayed game result.

The processor may be programmed to resolve the second wager according to whether the two cards of each player constitute a two-card poker hand of a predetermined rank or higher. Suitable predetermined winning ranks include: a two-card poker hand of a straight, a pair, a straight flush, or an ace and a king of the same suit. The processor may be further programmed to administer a first game of blackjack, three-card poker against a dealer hand, or three-card baccarat.

The processor may be programmed to receive a signal designating a player election to combine all or part of the second wager winnings with the first wager. In some examples, an instruction to accept all amounts won on the second wager, the amount wagered in the second wager or both to the first wager. The second wager may be mandatory or optional. The gaming machine may be configured for single player play or multiple player play. When the machine is configured for multiple player play, some examples include a common display, and multiple players may play the same game.

When the game is an electronic gaming machine (EGM), for single player use, the EGM may have a display screen and inputs for enabling game play of the wagering games. EGM may be linked with other EGMs and/or other gaming devices that may be operated, for example, by other players. Some EGMs include an upright player may located on a casino floor. Other electronic gaming devices may be portable devices that may be carried to different locations by the player.

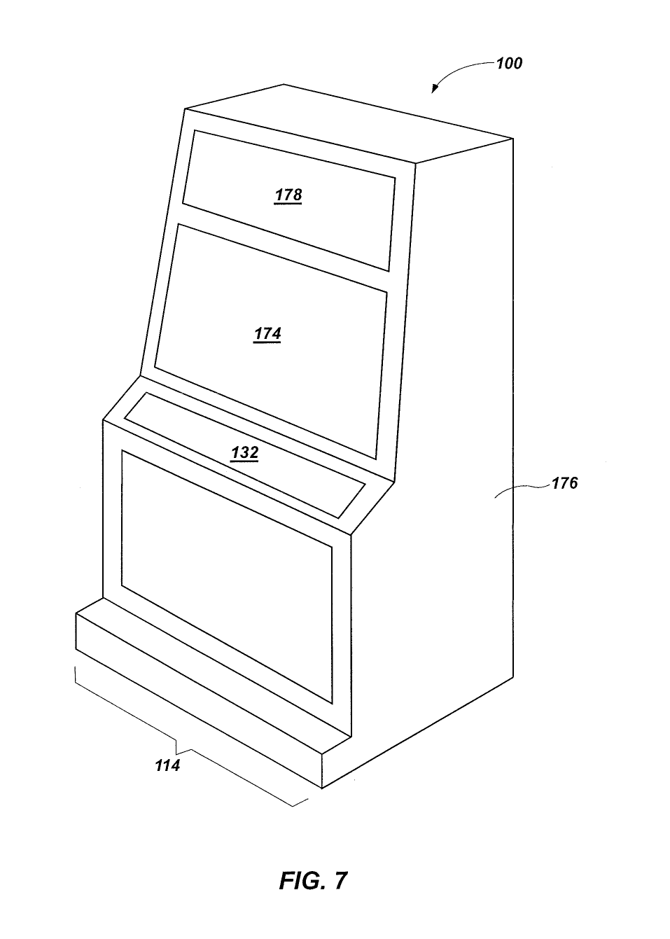

Referring to FIG. 7, an EGM 100, which is an example of an individual electronic gaming device 100 configured for implementation of embodiments of wagering games according to the present disclosure is shown. The EGM 100 may include an individual player position 114 that includes a player input area 132 for a player to interact with the individual electronic gaming device 100. The input area 132 may include touch screen controls and/or button controls. The electronic gaming device 100 may include a gaming screen 174 configured to display indicia for interacting with the individual electronic gaming device 100, such as through processing one or more stored programs to implement the rules of game play at the individual electronic gaming device 100. The screen 174 may also include touchscreen user controls. Accordingly, game play may be accommodated without involving physical playing cards, physical poker chips, and/or live personnel. The action may instead be simulated by a control processor (not shown) interacting with and controlling the individual EGM 100.

The gaming screen 174 may be carried by a generally vertically extending cabinet 176 of the EGM 100. The EGM 100 may further include banners (not shown) configured to communicate game identity, rules of game play, bonus features, entertainment features, attract features and/or the like, such as along a top portion 178 of the cabinet 176 of the EGM 100. The EGM 100 may further include additional decorative lights (not shown), and speakers (not shown) for transmitting and/or receiving sounds during game play. Further detail of an example of an individual electronic gaming device (as well as other embodiments of tables and devices) is disclosed in U.S. patent application Ser. No. 13/215,156, filed Aug. 22, 2011, and titled “Methods of Managing Play of Wagering Games and Systems for Managing Play of Wagering Games,” the disclosure of which is incorporated herein in its entirety by this reference.

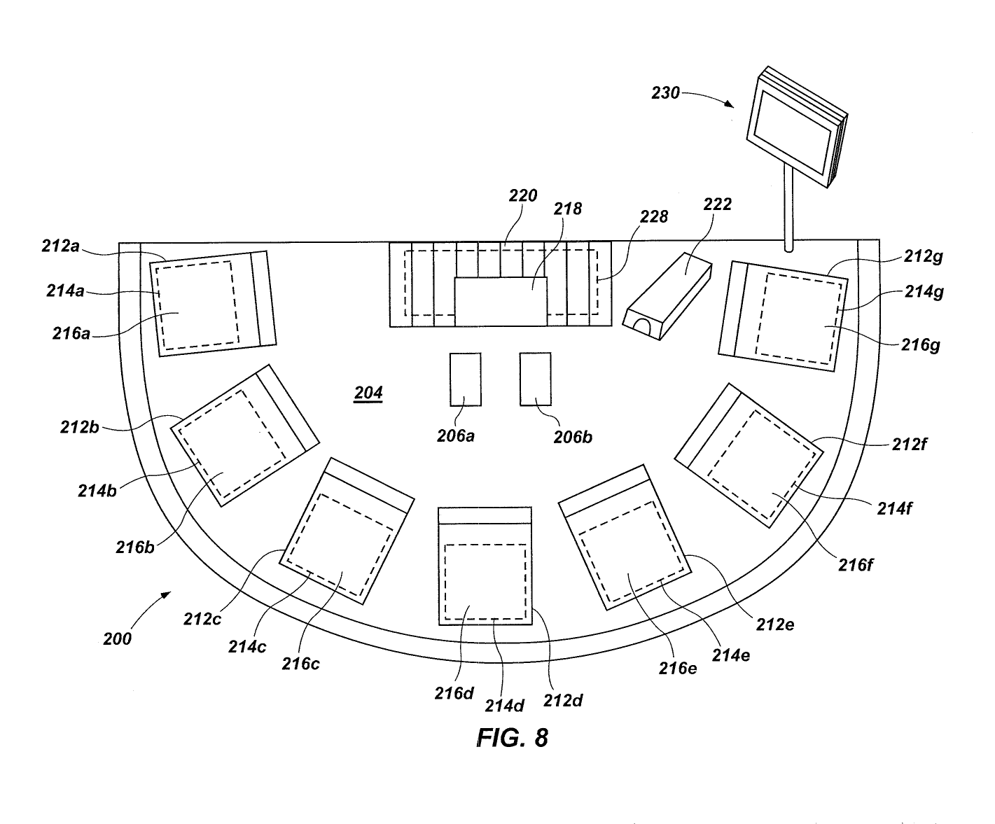

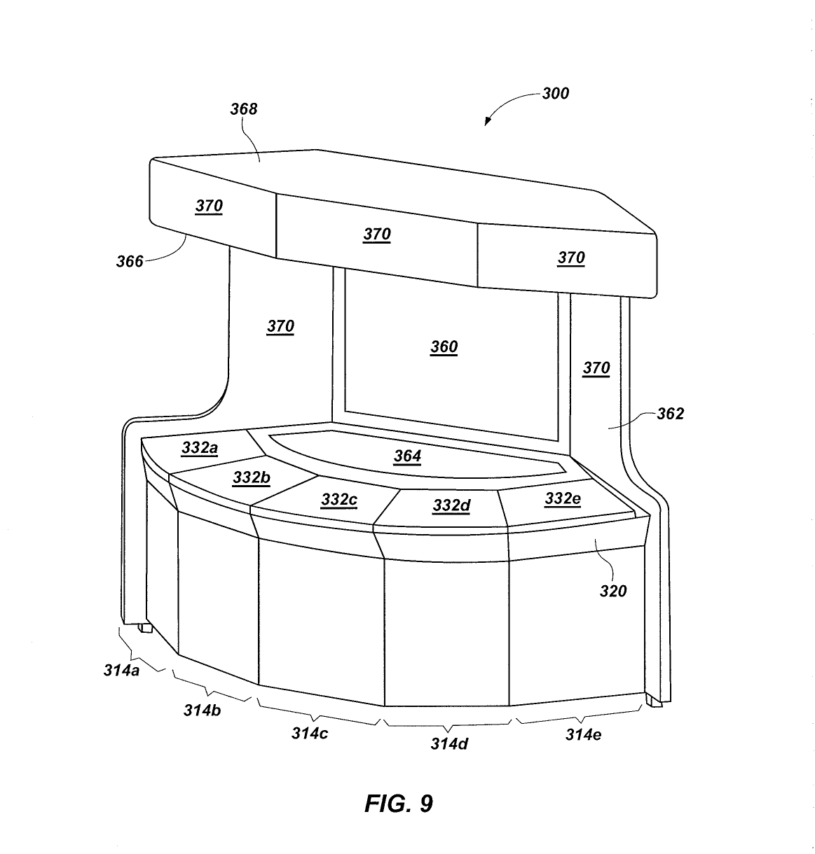

Some embodiments may include a plurality of player stations, as shown in FIG. 9, below. Such player stations may include a common electronic display screen 364 for display of game information, such as displaying virtual cards, virtual chips, and game instructions, and for accepting wagers and facilitating credit balance adjustments. Such player stations may, optionally, be integrated in a table format employing a live dealer, shown in FIG. 8. While some features may be automated through electronic interfaces (e.g., virtual cards, virtual chips, etc.), some features may remain in the physical domain. As such, the game play may be administered by a live dealer, a virtual dealer, with physical cards, card handling devices, physical chips or combinations thereof.

Referring to FIG. 8, a top plan view of an example of a suitable table 200 configured for implementation of embodiments of wagering games according to the present disclosure is shown. The table 200 may include a playing surface 204. The table 200 may include a plurality of player stations 212a-212g. Each player station 212a-212g may include an electronic player interface 216a-216g, which may be used for display of game information (e.g., game instructions, input options, wager information including virtual chips, game outcomes, etc.). The player interface 216a-216g may include a display screen in the form of a touch screen, which may in one embodiment be at least substantially flush with the playing surface 204. Each player interface 216a-216g may be coupled respectively with its own game processor 214a-214g (shown in dashed lines), although in some embodiments, a central game processor 228 (shown in dashed lines) may be employed. In some embodiments, a combination of individual game processors 214a-214g and a central game processor 228 may be employed.

The table 200 may further include additional features, such as a dealer chip tray 220, which may be used by the dealer to cash players in and out of the wagering game, whereas wagers and balance adjustments during game play may be performed electronically, and may be performed using virtual chips. For embodiments using physical cards 206a, 206b, the table 200 may further include a card handling device 222 that may be configured to shuffle, read, and deliver physical cards for the dealer and players to use during game play or, alternatively, a card shoe configured to read and deliver cards that have already been randomized. For embodiments using virtual cards, such virtual cards may be displayed at the individual player interfaces 216a-216g. Common virtual cards may also be displayed on a common display in a common card area (not shown).

The table 200 may further include a dealer interface 218, which, like the player interfaces 214a-214g, may include touch screen controls for assisting the dealer in administering the wagering game. The table 200 may further include an upright display 230 configured to display images that depict game information such as game identity, pay tables, hand counts, historical win/loss information by player, and a wide variety of other information considered useful to the players. The upright display 230 may be double sided to provide such information to players as well as to provide other types of information to casino pit personnel, such as player win/loss record, average amounts bet, previous wins/losses, etc.

Further detail of an example of a table and player displays is disclosed in U.S. Patent Application Pub. No. 2010/0016050, filed Jul. 15, 2008, now U.S. Pat. No. 8,262,475, issued Sep. 11, 2012, and titled “Chipless Table Split Screen Feature,” the disclosure of which is incorporated herein in its entirety by this reference. Although an embodiment is described showing individual discrete player stations, in some embodiments, the entire playing surface 204 may be an electronic display that is logically partitioned to permit game play from a plurality of players for receiving inputs from, and displaying game information to, the players, the dealer, or both.

Referring to FIG. 9, an example of a suitable multiple-player gaming machine 300 configured for implementation of embodiments of wagering games having a virtual dealer according to the present disclosure is shown. Games suitable for this type of machine include card games in which all players participate in the same game, simulating live casino game play. The table 300 may include player positions 314 that are arranged in a bank about an arcuate edge 320 that may comprise a common display screen 364 and a virtual dealer screen 360. The virtual dealer screen 360 may display a video simulation of the dealer (i.e., a virtual dealer) for interacting with the common display screen 364, such as through processing one or more stored programs to implement the rules of game play at the gaming machine 300. The dealer screen 360 may be carried by a generally vertically extending cabinet 362. The common player display screen 364 may be configured to display at least one or more of the dealer's cards, community cards, and/or player's cards by the virtual dealer depicted on the dealer screen 360 (virtual not depicted in FIG. 4).

Each of the player positions 314a-314e may include a player input area 332a-332e which is configured for wagering and game play interactions with the gaming machine 300 and/or virtual dealer. Accordingly, game play may be accommodated without involving physical playing cards, physical chips or other currency, and/or live personnel. The action may instead be simulated by a control processor (not shown) interacting with and controlling the gaming machine 300. The control processor may be located internally within, or otherwise proximate to, the gaming machine 300. The control processor (not shown) may be programmed, by known techniques, to implement the rules of game play at the gaming machine 300. As such, the control processor may interact and communicate with display/input interfaces and data entry inputs for each player area 332a-332e. Other embodiments of tables and gaming devices may include a control processor that may be similarly adapted to the specific configuration of its associated device.

The gaming machine 300 may further include banners (not shown) configured to communicate rules of play, pay tables and/or the like, which may be located along one or more walls 370 of the cabinet 362. The gaming machine 300 may further include additional decorative lights (not shown), functional lights (not shown) and speakers (not shown), which may be located on an underside surface 366, for example, of a generally horizontally depending top 368 of the cabinet 362 of the gaming machine 300 generally extending towards the player positions 314a-314e.

Further detail of an example of a table and player displays is disclosed in U.S. Patent Application Pub. No. 2005/0164762, filed Jan. 26, 2004, and titled “Automated Multiplayer Game table with Unique Image Feed of Dealer,” the disclosure of which is incorporated herein in its entirety by this reference. Although an embodiment is described showing individual discrete player stations, in some embodiments, the entire playing surface (e.g., player areas 332a-332e, card display screen 364, etc.) may be one unitary electronic display that is logically partitioned to permit game play from a plurality of players for receiving inputs from, and displaying game information to, the players, the dealer, or both.

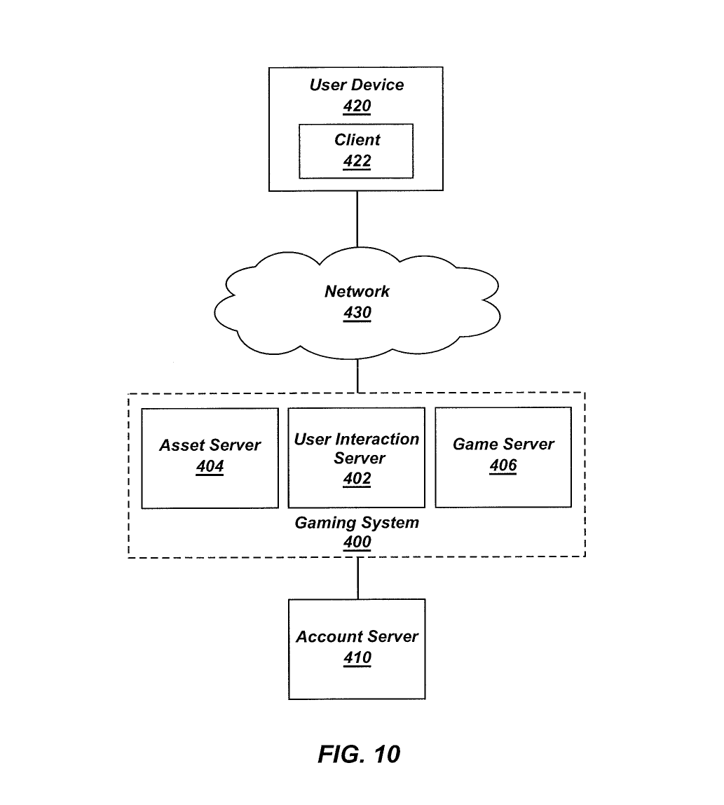

Wagering games in accordance with embodiments of the disclosure may be administered over the Internet, or otherwise on-line, using a gaming system employing a client server. Referring to FIG. 10, a schematic block diagram of a gaming system 400 for implementing wagering games according to an embodiment is shown. The gaming system 400 enables end users to access proprietary and/or non-proprietary game content. Such game content may include, without limitation, various types of wagering games such as card games, dice games, big wheel games, roulette, scratch tickets, and any other wagering game with a randomized element in determining wagering outcomes. This includes, but is not be limited to, Class II and Class III games as defined under 25 U.S.C. §2701 et seq. (“Indian Gaming Regulatory Act”). Such games may include house banked, player banked and player pooled games.

The wagering games supported by the gaming system 400 may be operated with real currency or with virtual credits. For example, the real currency option may be used with traditional casino and lottery-type wagering games in which money or other items of value are wagered and may be cashed out at the end of a game session. Real currency includes wagering on an account. The virtual credits option may be used with wagering games in which credits (or other symbols or tokens) may be issued to a player to be used for the wagers. A player may be credited with credits in any way allowed, including but not limited to a player purchasing credits, being awarded credits as part of a contest or a win event in this or another game (including non-wagering games), being awarded credits as a reward for use of a product, casino or other enterprise, time played in one session, games played, etc. Although credits may be won or lost, the ability of the player to cash out credits may be controlled or prevented. In one example, credits purchased for use in a play for fun game may be limited to non-monetary redemption items, awards, or credits usable in the future or for another game or gaming session. The same credit redemption restrictions may be applied to some or all of credits won in a wagering game as well.

An additional variation includes sites having both play for fun and wagering games, including issuance of free credits usable to play the play for fun games. This may attract players to the site and to the games before they engage in real wagering. In some embodiments, a limited number free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The system may enable players to buy additional game credits to allow the player to resume play. Objects of value may be awarded to play for fun players, which may or may not be in a direct exchange for credits. For example, a prize may be awarded or won for a highest scoring play for fun player during a defined time interval. All variations of credit redemption are contemplated, as desired by game designers and game hosts (the person or entity controlling the hosting systems).

The gaming system 400 may include a gaming platform that establishes a portal for an end user to access a wagering game hosted by a game server 406 through a user interaction server 402. The user device 420 may communicate with a user interaction server 402 of the gaming system 400 using a network 430 (e.g., the Internet). The user interaction server 402 may communicate with the game server 406 and provide game information to the user. In some embodiments, the game server 406 may also be a game engine. In some embodiments, a single user device 420 communicates with a game provided by the game server 406, while other embodiments may include a plurality of user devices 420 configured to communicate and provide end users with access to the same game provided by game server 406. In addition, a plurality of end users may access a single user interaction server 402, or, a plurality of user interaction servers 402 to access game server 406.

The user interaction server 402 may communicate with the user device 420 to enable access to the gaming system 400. The user interaction server 402 may enable a user to create and access a user account and interact with game server 406. The user interaction server 402 may enable users to initiate new games, join existing games, and interface with games being played by the user.

The user interaction server 402 may also provide a client 422 for execution on the user device for accessing the gaming system 400. The client 422 provided by the gaming system 400 for execution on the user device 420 can comprise a variety of implementations according to the user device and method of communication with the gaming system 400. In one embodiment, the user device 420 connects to the gaming system 400 using a web browser and the client 422 executes within a browser window or frame of the web browser. In another embodiment, the client 422 is a stand-alone executable on the user device 420.

In one embodiment, the client 422 may comprise a relatively small amount of script (e.g., JAVASCRIPT®), also referred to as a “script driver,” including scripting language that controls an interface of the client 422. The script driver may include simple function calls requesting information from the gaming system 400. In other words, the script driver stored in the client 422 may merely include calls to functions that are externally defined by, and executed by, the gaming system 400. As a result, the client 422 may be characterized as a “thin client.” As that term is used herein, the client 422 may be little more than a script player. The client 422 may simply send requests to the gaming system 400 rather than performing logic itself. The client 422 receives player inputs and the player inputs are passed to gaming system 400 for processing and executing the wagering game. In one embodiment, this includes providing specific graphical display information to client 422 as well as game outcomes.

In other embodiments, the client 422 comprises an executable code rather than a script. In that case, client 422 may do more local processing than does a script driver, such as calculating where to show what game symbols upon receiving a game outcome from game server 406 through user interaction server 402. In one embodiment, it may be that data files stored on asset server 404 are loaded onto the client 422, and used by the client in processing and updating graphical displays. Due to security and integrity concerns, most embodiments will have the bulk of the processing of the game play performed in the gaming system 400. However, some embodiments may include significant game processing by client 422 when the client and user device 420 are considered trustworthy, or, when there is reduced concern for security and integrity in the displayed game outcome. In most embodiments, it is expected that some form of data protection, such as end-to-end encryption, will be used when data is transported over network 430. Network 430 may be any network, including but not limited to the Internet, or a casino network.

In an embodiment where the client 422 implements further logic and game control methodology beyond the thin client, the client 422 may parse and define player interactions prior to passing the player interactions to the gaming system 400. Likewise, when the client 422 receives a gaming interaction from the gaming system 400, the client 422 may be configured to determine how to modify the display as a result of the gaming interaction. The client 422 may also allow the player to change a perspective or otherwise interact with elements of the display which do not change aspects of the game.

The gaming system 400 may include an asset server 404 which may host various media assets (e.g., audio, video, and image files) that may be sent to the client 422 for presenting the various wagering games to the end user. In other words, in this embodiment the assets presented to the end user may be stored separately from the client 422. In one embodiment, the client 422 requests the assets appropriate for the game played by the user; in other embodiments, especially those using thin clients, just those assets that are needed for a particular display event will be sent by game server 400 when the game server determines they are needed, including as few as one asset. In one example, the client 422 may call a function defined at the user interaction server 402 or asset server 404 which may determine which assets are to be delivered to the client 422 as well as how the assets are to be presented by the client 422 to the end user. Different assets may correspond to the various clients that may have access to the game engine 406 or to different games to be played.

The game server 406 is configured to perform game play methods and determine game play outcomes that are provided to the user interaction server 402 to be transmitted to user device 420 for display on the end user's computer. For example, the game server 406 may include game rules for one or more wagering games, such that the game server 406 controls some or all of the game flow for a selected wagering game, as well as the determining game outcomes. Game server 406 may include pay tables, game rules and other game logic. The game server 406 may also perform random number generation for determining random game elements of the wagering game. In other embodiments, random game elements are generated in a separate server (not shown). In one embodiment, the game server 406 is separated from the user interaction server 402 by a firewall or other method of preventing unauthorized access to the game server 406 from the general members of the network 430.

The user device 420 may present a gaming interface to the player and communicate the user interaction to the gaming system 400. The user device 420 may be any electronic system capable of displaying gaming information, receiving user input, and communicating the user input to the gaming system 400. As such, the user device 420 can be a desktop computer, a laptop, tablet computer, set-top box, mobile device including but not limited to smart phones, kiosk, terminal, or other computing device. The user device 420 may operate the client 422 for connecting to the interactive gaming system 400 as described above. The client 422 may be a specialized application or may be executed within a generalized application capable of interpreting instructions from the interactive gaming system 400, such as a web browser.

The client 422 may interface with an end user through a web page, or an application that runs on a device including but not limited to a smartphone, tablet, or general computer, or be any other computer program configurable to access the gaming system 400. The client 422 may be illustrated within a casino webpage (or other interface) indicating that the client 422 is embedded into a webpage, which is supported by a web browser executing on the client device 420.

In one embodiment, the gaming system 400 may be accessed by multiple different entities. The user device 420 may be operated by a third party, such as a casino or an individual, that links to the gaming system 400, which may be operated, for example, by a wagering game service provider. Therefore, in some embodiments, the user device 420 and client 422 may be operated by a different administrator than the operator of the game server 406. In other words, the user device 420 may be part of a third-party system that does not administer or otherwise control the gaming system 400 or game server 406. In another embodiment, the user interaction server 402 and asset server 404 are provided by a third-party system. For example, a gaming entity (e.g., a casino) may operate the user interaction server 402 or user device 420 to provide its customers access to game content managed by a different entity which may control game server 406, amongst other functionality. In some embodiments, these functions are operated by the same administrator. For example, a gaming entity (e.g., a casino) may elect to perform each of these functions in-house, such as providing both the access to the user device 420 and the actual game content and providing administration of the gaming system 400.

The gaming system 400 may communicate with external account servers 410, optionally through another firewall. For example, the gaming system 400 itself may not directly accept wagers or issue payouts. That is, the gaming system 400 may facilitate online casino gaming, but may not be part of a self-contained online casino itself. Instead, the gaming system 400 may facilitate the play of wagering games owned and controlled by a company offering games and gaming products and services, such as Shuffle Master, Inc. Another entity (e.g., a casino or any account holder or financial system of record) may operate and maintain its external account servers 410 to accept bets and make payout distributions. The gaming system 400 may communicate with the account servers 410 to verify the existence of funds for wagering, and instruct the account server 410 to execute debits and credits.

In some embodiments, the gaming system 400 may directly accept bets and make payout distributions, such as in the case where an administrator of the gaming system 400 operates as a casino. As discussed above, the gaming system 400 may be integrated within the operations of a casino rather than separating out functionality (e.g., game content, game play, credits, debits, etc.) among different entities. In addition, for play for fun wagering games, the gaming system 400 may issue credits, take bets, and manage the balance of the credits according to the game outcomes, but may not permit payout distributions or be linked to account server 410 that permits payout distributions. Such credits may be issued for free, through purchase, or for other reasons, without the ability for the player to cash out. Such play for fun wagering games may be played on platforms that do not permit traditional gambling, such as to comply with jurisdictions that do not permit online gambling.

The gaming system 400 may be configured in many ways, from a fully integrated single system to a distributed server architecture. The asset server 404, user interaction server 402, game server 406, and account server 410 may be configured as a single, integrated system of code modules running on a single server or machine, where each of the servers is functionality implemented on a single machine. In such a case, the functionality described herein may not be implemented as separate code modules. The asset server 404, user interaction server 402, game server 406, and account server 410 may also be implemented as a plurality of independent servers, each using its own code modules running on a separate physical machine, and may further include one or more firewalls between selected servers (depending on security needs). Each server could communicate over some kind of networked connection, potentially as varied as that described for network 430. Further, each single server shown in FIG. 5 may be implemented as a plurality of servers with load balancing and scalability factors built into the embodiment. All such embodiments and variations are fully contemplated.

Additional features may be supported by the game server 406, such as hacking and cheating detection, data storage and archival, metrics generation, messages generation, output formatting for different end user devices, as well as other features and operations. For example, the gaming system 400 may include additional features and configurations as described in U.S. patent application Ser. No. 13/353,194, filed Jan. 18, 2012, and titled “Network Gaming Architecture, Gaming Systems, and Related Methods,” which is incorporated by reference herein in its entirety by this reference.

The network 430 may enable communications between the user device 420 and the gaming system 400. A network (not shown) may also connect the gaming system 400 and account server 410, and further one or more networks may interconnect one or more of the other servers shown collectively as game system 400. In one embodiment, the network 430 uses standard communications technologies and/or protocols. Thus, the network 430 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 430 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 430 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 430 can include links comprising one or more networks such as the Internet.

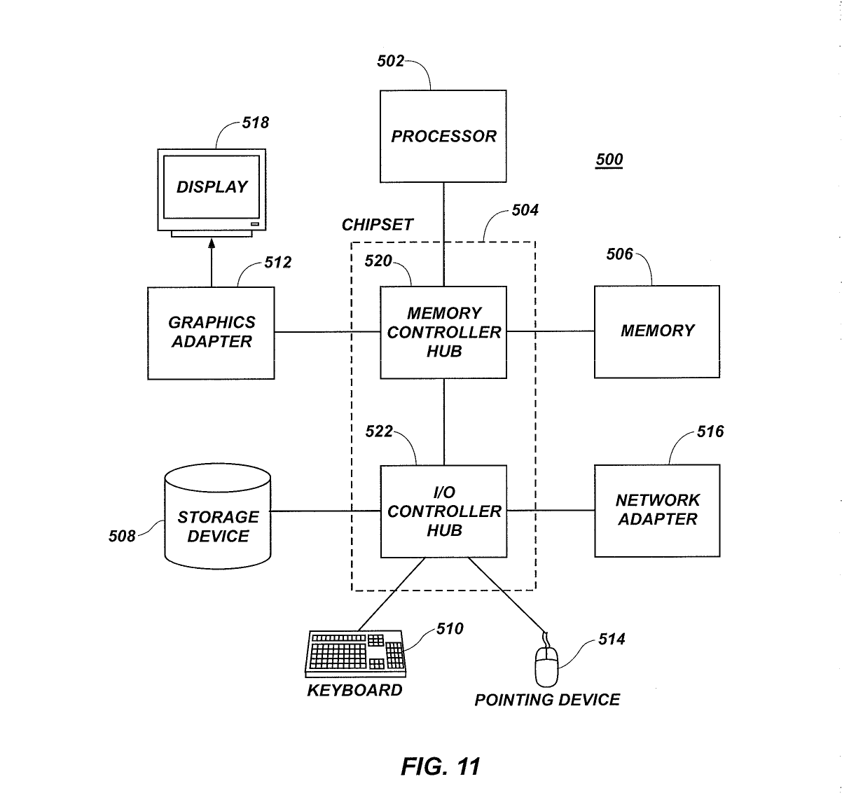

Referring to FIG. 11, a high-level block diagram of a computer 500 for acting as a gaming system 400 according to one embodiment is shown. Illustrated are at least one processor 502 coupled to a chipset 504. Also coupled to the chipset 504 are a memory 506, a storage device 508, a keyboard 510, a graphics adapter 512, a pointing device 514, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is any non-transitory computer-readable storage medium, such as a hard drive, compact disk read-only memory (CD-ROM), DVD, or a solid-state memory device (e.g., a flash drive). The memory 506 holds instructions and data used by the processor 502. The pointing device 514 may be a mouse, track ball, or other type of pointing device, and is used in combination with the keyboard 510 to input data into the computer system 500. The graphics adapter 512 displays images and other information on the display 518. The network adapter 516 couples the computer system 500 to a local or wide area network.

As is known in the art, a computer 500 can have different and/or other components than those shown in FIG. 11. In addition, the computer 500 can lack certain illustrated components. In one embodiment, a computer 500 acting as a gaming system 400 lacks a keyboard 510, pointing device 514, graphics adapter 512, and/or display 518. Moreover, the storage device 508 can be local and/or remote from the computer 500 (such as embodied within a storage area network (SAN)).

The gaming system 400 may comprise several such computers 500. The gaming system 400 may include load balancers, firewalls, and various other components for assisting the gaming system 400 to provide services to a variety of user devices.

As is known in the art, the computer 500 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 508, loaded into the memory 506, and executed by the processor 502.

Embodiments of the entities described herein can include other and/or different modules than the ones described here. In addition, the functionality attributed to the modules can be performed by other or different modules in other embodiments. Moreover, this description occasionally omits the tern “module” for purposes of clarity and convenience.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “determining,” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware, or hardware, and when embodied in software, could be downloaded to reside on and be operated from different platforms used by a variety of operating systems. The embodiments can also be in a computer program product which can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), FPGA or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

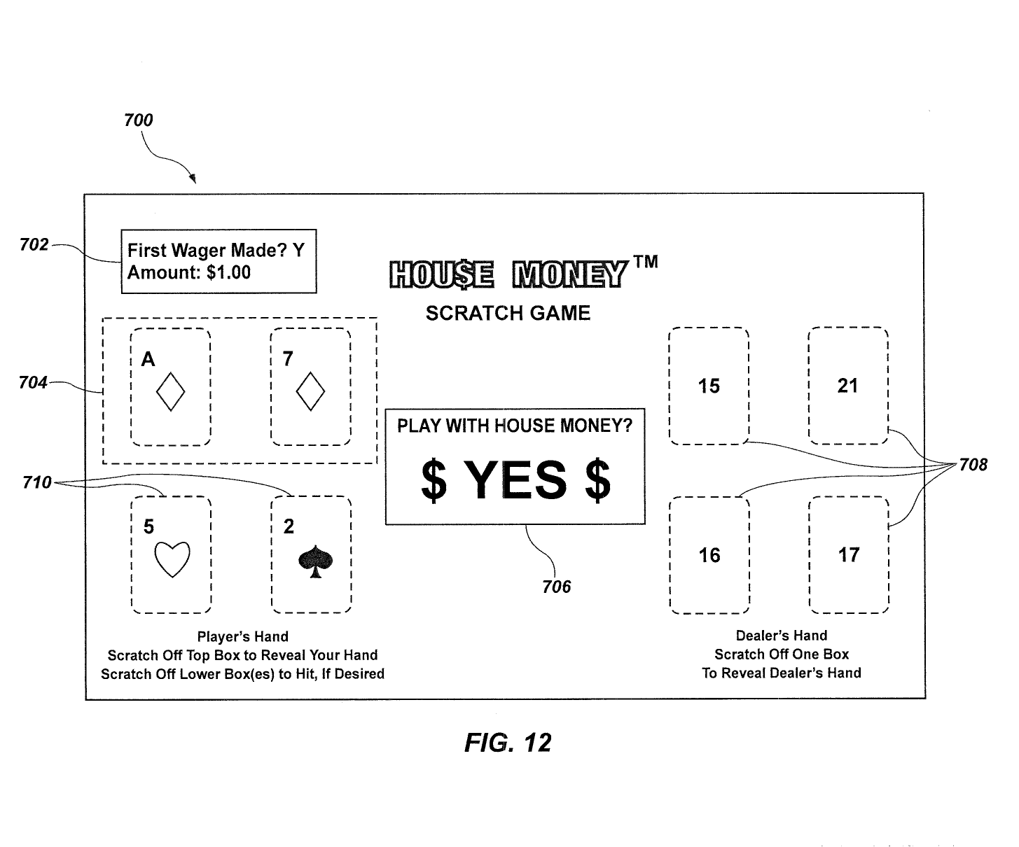

With reference to FIG. 12, an example of a wagering game implemented as a scratch card 700 as an on-line game or lottery-type scratch ticket is shown. A player may purchase a physical scratch card 700 or may access a virtually displayed scratch card 700. In some embodiments, a verification code 702 may be displayed (e.g., printed) on the scratch card 700 to indicate whether a player made the first wager and optionally the amount of the first wager, for example, where the amount of the first wager is not fixed by the seller. In other embodiments, a portion of the purchase price of the scratch card 700 may be mandatorily allocated to the first wager and a remainder of the purchase price of the scratch card 700 may be mandatorily allocated to the second wager. For example, 33% of the purchase price may be allocated to the first wager and 67% of the purchase price may be allocated to the second wager.

In some embodiments, the player may then scratch off an opaque covering over an area 704 to reveal individual images of cards that may be said to have been dealt to the player. In other embodiments, the player may scratch off individual opaque coverings over distinct areas of a virtual scratch card 700 to reveal two images of cards that may be said to have been dealt to the player. Such scratching off, and other scratching described below, may involve scraping physical opaque coverings from a physical scratch card 700 or may involve digitally concealing and subsequently digitally revealing (e.g., displaying a blank area and subsequently displaying card values in that area) electronic images on an electronic image of a scratch card 700. If the suit and rank of the cards dealt to the player constitute a royal flush, a straight flush, a pair, or a straight, then the first wager is resolved in the player's favor. In some embodiments, such a first set of rules for resolving the first wager may be displayed on the scratch card 700. If the suit and rank of cards dealt to the player do not constitute a winning two-card poker hand, the player loses at least the amount of the first wager.

In some embodiments, the player may select whether to risk or keep winnings from the first wager (and optionally the amount of the first wager itself) at the time of purchase, and the player's selection may be displayed (e.g., printed) using another verification code 706 on the scratch card 700. In other embodiments, a player may indicate whether he would like to keep or to risk an entire amount of the winnings (optionally including the first wager) by scratching off an appropriate label, one label to retain them and another label to add them to the second wager. Such a scratch card 700 may require supervision to ensure that a player scratches off the labels in the proper order (i.e., after scratching off the appropriate area 704 or areas for the player's cards and before scratching off any other areas 708 for the dealer's cards).

In some embodiments, the player may then scratch one of a plurality of other opaque coverings over a plurality of other areas 708 (e.g., 3, 4, 5, etc.) to reveal individual total combined card rankings of cards that may be said to have been dealt to the dealer. In other embodiments, the player may scratch off a single opaque covering over an area of the scratch card 700 to reveal two images of cards that may be said to have been dealt to the dealer or may scratch off two opaque coverings over two areas among a plurality of areas to reveal two individual cards that may be said to have been dealt to the dealer. In some embodiments, the scratch card 700 may comprise additional opaque coverings over additional areas 710 (e.g., 2, 3, 4, 5, etc.) to reveal individual hit cards that may be said to have been dealt to the player. Such a configuration may enable a player to make and resolve the first wager using only the cards in the area 704, to evaluate the dealer's hand, and to elect to stand using only the cards in the area 704 or to hit and play with one or more of the additional cards in the additional areas 710. If the combined rank of the player's cards is greater than the combined rank of the dealer's cards according to the rules of blackjack, without exceeding 21, then the second wager is resolved in the player's favor. The player may redeem the scratch card 700 for the appropriate amount of winnings. If the combined rank of the player's cards is less than the combined rank of the dealer's cards, then the scratch card 700 may only be redeemed for value in embodiments where the player won the first wager and elected to keep the winnings from the first wager (and optionally the first wager itself).

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of embodiments encompassed by the disclosure as contemplated by the inventor.

1. A method of administering a wagering game, comprising:
accepting a first wager to participate in a first wagering game according to a first set of game rules;
accepting a second wager to participate in a second, different wagering game according to a second, different set of game rules;
dealing cards to each player and to a dealer;
resolving the second wager according to the second set of game rules;
accepting from each player for whom the second wager is resolved in favor of that player an instruction to award at least a portion of winnings from the second wager directly to the player or to add at least a portion of winnings from the second wager to the first wager; and
resolving the first wager according to the first set of game rules.

2. The method of claim 1, wherein resolving the second wager according to the second set of game rules comprises resolving the second wager according to whether the two cards of each player constitute a two-card poker hand of a predetermined rank or higher.

3. The method of claim 1, wherein the second wager is resolved before the first wager is resolved.

4. The method of claim 1, wherein the different set of game rules is selected from the group consisting of two-card poker rankings, three-card poker rankings, four-card poker rankings, five-card poker rankings, six-card poker rankings and seven-card poker rankings.

5. The method of claim 4, wherein a number of cards dealt to each player is selected from the group consisting of 2, 3, 4, 5, 6 and 7 cards.

6. The method of claim 4, wherein a number of cards dealt to each player is selected from the group consisting of 3, 4, 5, 6, 7 and 8 cards, and at least one card is discarded.

7. The method of claim 1, wherein at least one dealt player card is a community card.

8. The method of claim 4, wherein the different set of game rules comprises a predetermined set of winning poker rankings and corresponding payout odds.

9. The method of claim 2, wherein resolving the second wager according to whether the two cards of each player constitute a two-card poker hand of the predetermined rank or higher comprises resolving the second wager according to whether the two cards of each player constitute a two-card poker hand of a straight, a pair, a straight flush, or a royal flush.

10. The method of claim 1, wherein resolving the first wager according to the first set of game rules comprises resolving the first wager according to blackjack rules.

11. The method of claim 10, wherein the dealer evaluates the dealer hand and when the dealer hand is a blackjack, the dealer pays players who had a winning payout under the different set of rules and does not combine all or part of the second wager and second wager payouts to the first wager.

12. The method of claim 1, wherein the second wager is optional.

13. The method of claim 1, and when the second wager is resolved in favor of the player and when the dealer accepts an election from the player to combine all the winnings on the second wager to the first wager, the winnings from the second wager are added to the first wager before play continues.

14. The method of claim 13, and further comprising adding the second wager amount to the first wager amount.

15. The method of claim 1, wherein the first set of game rules comprises dealing three cards to each player and the dealer, and comparing a point value of the player hands to the dealer hand, wherein baccarat rules determine the point value of the hands.

16. The method of claim 15, wherein the different set of game rules comprises playing a three-card poker hand against a pay table.

17. The method of claim 15, and further comprising the dealer receiving an ante wager from the player, and comparing a three-card poker ranking of the player hand and the dealer hand, and paying the player a payout when the player hand outranks the dealer hand, using a three-card poker ranking system.

18. A method of administering a wagering game, comprising:
accepting a first wager to participate in a game of blackjack;
accepting a second wager to participate in a variant of a two-card poker game;
dealing two cards to each player and to a dealer;
resolving the second wager according to whether the two cards of each player constitute a two-card poker hand of a predetermined rank or higher;
accepting from each player in whose favor the second wager is resolved an instruction to award at least a portion of winnings from the second wager directly to the player or to add at least a portion of winnings from the second wager to the first wager; and
resolving the first wager according to blackjack rules.

19. The method of claim 18, wherein resolving the second wager according to whether the two cards of each player constitute a two-card poker hand of the predetermined rank or higher comprises resolving the second wager according to whether the two cards of each player constitute a two-card poker hand of a straight, a pair, a straight flush, or an ace and a king of the same suit.

20. The method of claim 19, wherein each predetermined rank has the following corresponding payout odds:

| Hand | Odds |
|---|---|
| Ace-king suited | 9:1 |
| Straight flush | 4 or 5:1 |
| Pair | 3:1 |
| Straight | 1:1 |

wherein a straight flush pays 4:1 when multiple decks of cards are used and the straight flush pays 5:1 when a single deck of cards is used.

21. The method of claim 18, further comprising awarding an odds payout to each player in whose favor the second wager is resolved.

22. The method of claim 18, wherein the second wager is optional.

23. The method of claim 18, wherein the second wager is mandatory or optional, and when the second wager is made, the second wager is resolved before the first wager is resolved.

24. The method of claim 18, and when the second wager is resolved in the player's favor, the dealer adding all of the winnings to the first wager when the dealer receives an election from the player to combine all of the second wager winnings to the first wager.

25. The method of claim 24, and further comprising adding the second wager to the first wager upon the dealer receiving an election to combine all of the second wager to the first wager.

26. A gaming table for administering a wagering game, comprising:
a playing surface including at least one player interface;
at least one dealer interface; and
at least one processor programmed to:
accept a first wager to participate in a first wagering game according to a first set of game rules;
accept a second wager to participate in a second, different wagering game according to a second, different set of game rules;
resolve the second wager according to the second set of game rules;
accept from each player in whose favor the second wager is resolved an instruction to award at least a portion of winnings from the second wager directly to the player or to add at least a portion of winnings from the second wager to the first wager; and
resolve the first wager according to the first set of game rules.

27. The gaming table of claim 26, wherein the at least one processor is programmed to resolve the second wager according to whether the two cards of each player constitute a two-card poker hand of a predetermined rank or higher.

28. The gaming table of claim 26, wherein the at least one processor is programmed to resolve the second wager according to whether the two cards of each player constitute a two-card poker hand of a straight, a pair, a straight flush, or an ace and a king of the same suit.

29. The gaming table of claim 26, wherein the at least one processor is programmed to resolve the second wager according to blackjack rules.

30. The gaming table of claim 26, and when the second wager is resolved in favor of the player, accepting an instruction to add all of the winnings to the first wager.

31. The gaming table of claim 30, and further accepting an instruction to add all of the second wager to the first wager.

32. The gaming table of claim 26, wherein the second wager is optional.

33. A system for administering a wagering game over a computer network, comprising:
a game engine configured to be accessed by a client server over a network, the game engine being programmed to:
accept an instruction from a client server to place a first wager to participate in a first wagering game according to a first set of game rules;
accept an instruction from the client server to place a second wager to participate in a second, different wagering game according to a second, different set of game rules;
resolve the second wager according to the second set of game rules;
accept an instruction from each player for whom the first wager is resolved favorably an instruction to award at least a portion of at least one of the second wager and winnings from the second wager directly to the player or to add all or a portion of said amounts to the first wager; and
resolve the first wager according to the first set of game rules.

34. The system of claim 33, wherein the second wager is optional.

35. The system of claim 33, wherein the game engine is programmed to resolve the second wager according to whether the two cards of each player constitute a two-card poker hand of a predetermined rank or higher.

36. The system of claim 35, wherein the game engine is programmed to resolve the second wager according to whether the two cards of each player constitute a two-card poker hand of a straight, a pair, a straight flush, or an ace and a king of the same suit.

37. The system of claim 33, wherein the game engine is programmed to resolve the first wager according to blackjack rules.

38. The method of claim 33, wherein the dealer returns the second wager and winnings on the second wager to the player when the dealer hand is a blackjack.

39. An electronic gaming machine for administering a wagering game, comprising:
at least one player display and at least one player interface; wherein the player interface enables a player to input a wager instruction;
at least one processor programmed to:
accept a player first wager instruction to participate in a first wagering game according to a first set of game rules;
accept a player second wager instruction to participate in a second, different wagering game according to a second, different set of game rules;
display a game result;
resolve the second wager according to the second set of game rules;
accept from each player in whose favor the second wager is resolved an instruction to award at least a portion of winnings from the second wager directly to a player account or to add at least a portion of winnings from the second wager to the first wager; and
resolve the first wager according to the first set of game rules based on at least the same displayed game result.

40. The gaming machine of claim 39, wherein the at least one processor is programmed to resolve the second wager according to whether the two cards of each player constitute a two-card poker hand of a predetermined rank or higher.

41. The gaming machine of claim 39, wherein the at least one processor is programmed to resolve the second wager according to whether the two cards of each player constitute a two-card poker hand of a straight, a pair, a straight flush, or an ace and a king of the same suit.

42. The gaming machine of claim 39, wherein the at least one processor is programmed to resolve the second wager according to blackjack rules.

43. The gaming machine of claim 39, and when the second wager is resolved in favor of the player, accepting an instruction to add all of the winnings to the first wager.

44. The gaming machine of claim 43, and further accepting an instruction to add all of the second wager to the first wager.

45. The gaming machine of claim 39, wherein the second wager is optional.

46. The gaming machine of claim 39, wherein the machine is adapted for single player play.

47. The gaming machine of claim 39, and further comprising a common display, wherein the machine is adapted for multiple players to play the same game.
